(19) United States
(12) Patent Application Publication
(10) Pub. No.: US 2024/0149763 A1
(43) Pub. Date: May 9, 2024

(54) VEHICLE SEAT MOUNTING DEVICE AND METHOD OF USE

(71) Applicant: Tim Ross O'Banion, Sioux Falls, SD (US)

(72) Inventor: Tim Ross O'Banion, Sioux Falls, SD (US)

(21) Appl. No.: 17/982,140

(22) Filed: Nov. 7, 2022

(51) Int. Cl. B60N 2/50; B60N 2/54

(52) U.S. Cl. CPC B60N 2/504; B60N 2/544; B60N 2/015

(57) ABSTRACT

A vehicle seat mounting device for reducing a risk of sustaining a spinal or back injury includes a first mounting element, which in turn comprises a pair of side members. Each side member, which comprises at least one compressible element, is attachable to a chassis so that the pair of side members defines a seating area. A crossmember is attached to and extends between the side members and across the seating area. The crossmember is attachable to a seat portion of a vehicle seat so that the vehicle seat is mounted to the chassis. The compressible elements at least partially absorb a force applied to a bottom of the chassis and substantially parallel to the side members.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to seat mounting devices and more particularly pertains to a new seat mounting device for reducing a risk of sustaining a spinal or back injury. The present invention discloses a seat mounting device that positions compressible elements in a bracketing configuration relative to a vehicle seat to which they are attached. The compressible elements counteract a vertical force applied to a bottom of a chassis to which the seat mounting device and the vehicle seat are attached to reduce reducing a risk of sustaining a spinal or back injury.

### (2) Description of Related Art Including Information Disclosed Under 37 CFR 1.97 and 1.98

The prior art relates to seat mounting devices. U.S. Patent Application 2020/0269734, which discloses a seat mounting device comprising a first element that attaches to a vehicle chassis and a vehicle seat so that the vehicle seat is movable in at least one direction relative to the vehicle chassis. The first element includes a compressible member that is configured to absorb impact forces between the vehicle chassis and the vehicle seat. The system is positioned between the vehicle seat and the chassis and of necessity must have a low profile and allow limited range of motion of the vehicle seat relative to the vehicle chassis. For this reason, the compressible member comprises a high density foam material.

Other prior art seat mounting devices may comprise hydraulic cylinders or electronic actuators, which are positioned between car seats and vehicle bodies to produce motion of the car seats to counteract influence of vehicle body motion on the car seats, but which are not intended to mitigate vertical impact forces applied to the car seats.

Related prior art includes mechanisms for selectively raising and lowering car seats and fixedly positioning them at selected positions, without means for mitigating vertical impact forces. Additional related prior art comprises shock absorbers incorporated into chassis of racing cars to absorb torque generated during acceleration and deceleration, but which do not mitigate vertical impact forces applied to the chassis. Still more related prior art comprises foam blocks, which are selectively positionable under car seats of race cars to reduce a likelihood of injury in event of torque tube failures.

What is lacking in the prior art is a seat mounting device comprising a first mounting element, which in turn comprises a pair of side members joined by a crossmember to which a vehicle seat is attachable. Each side member comprises at least one compressible element. The side members are attachable to a chassis and bracket the vehicle seat, a configuration not shown in the prior art and allowing for greater range of motion of the vehicle seat relative to prior art seat mounting devices.

### (h) BRIEF SUMMARY OF THE INVENTION

An embodiment of the disclosure meets the needs presented above by generally comprising a first mounting element, which in turn comprises a pair of side members. Each side member, which comprises at least one compressible element, is configured to be attachable to a chassis so that the pair of side members defines a seating area. A crossmember is attached to and extends between the side members and across the seating area. The crossmember is configured to be attachable to a seat portion of a vehicle seat so that the vehicle seat is mounted to the chassis. The compressible elements are configured to at least partially absorb a force applied to a bottom of the chassis and substantially parallel to the side members.

Another embodiment of the disclosure includes a vehicle seat mounting system, which comprises a chassis, a vehicle seat, and a vehicle seat mounting device, according to the disclosure above. A pair of side members of the vehicle seat mounting system are attached to the chassis to define a seating area. Each side member comprises at least one compressible element. A crossmember of the vehicle seat mounting system is attached to and extends between the side members and across the seating area. The crossmember is attached to a seat portion of the vehicle seat so that the vehicle seat is mounted to the chassis. The compressible elements are configured to at least partially absorb a force applied to a bottom of the chassis and substantially parallel to the side members.

Yet another embodiment of the disclosure includes a method for reducing a risk of sustaining a spinal or back injury comprising a provision step, which entails providing a chassis, a vehicle seat, and a vehicle seat mounting device, according to the disclosure above. First and second assembly steps of the method entail attachment of side members of the vehicle seat mounting device to a chassis and attachment of a seat portion of the vehicle seat to a crossmember of the vehicle seat mounting device, respectively. The compressible elements are configured to at least partially absorb a force applied to a bottom of the chassis and substantially parallel to the side members

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective, in-use view of a vehicle seat mounting device according to an embodiment of the disclosure.

FIG. 2 is a detail view of an embodiment of the disclosure.

FIG. 3 is a cross-sectional view of an embodiment of the disclosure.

FIG. 4 is a detail, in-use view of an embodiment of the disclosure.

FIG. 5 is an exploded view of an embodiment of the disclosure.

FIG. 6 is an in-use view of an embodiment of the disclosure.

FIG. 7 is a detail, in-use view of an embodiment of the disclosure.

FIG. 8 is a flow diagram for a method utilizing an embodiment of the disclosure.

### (j) DETAILED DESCRIPTION OF THE INVENTION

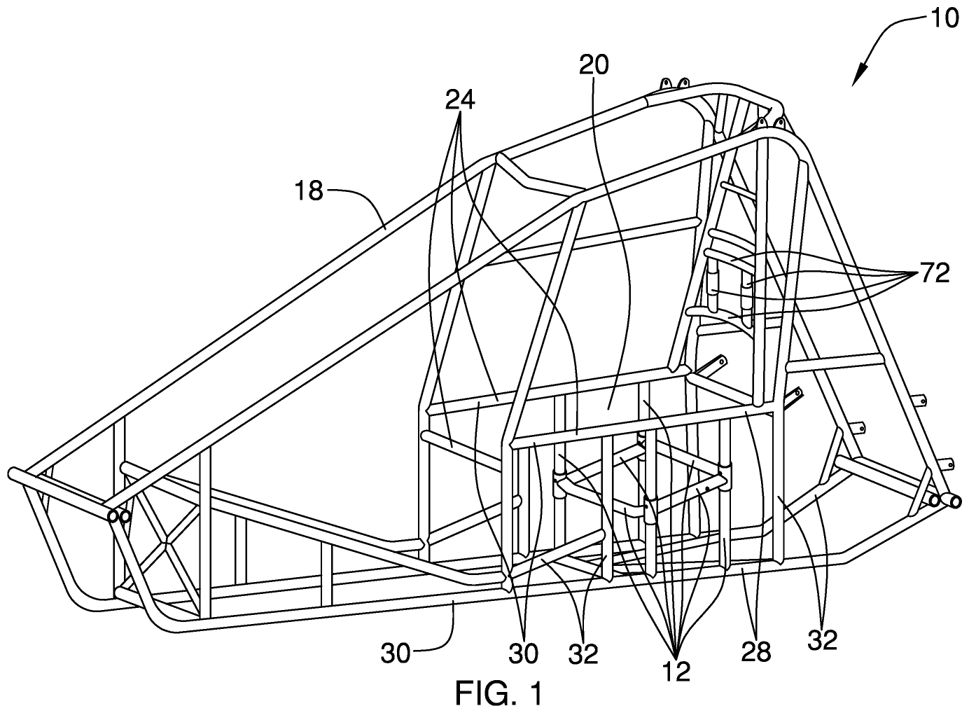

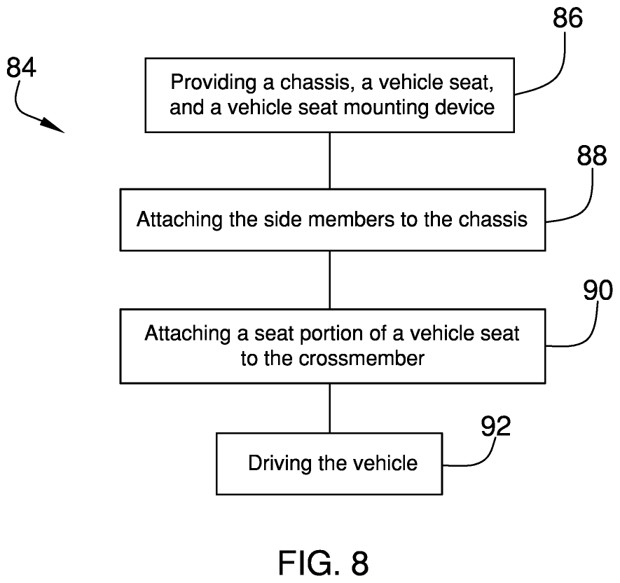

With reference now to the drawings, and in particular to FIGS. 1 through 8 thereof, a new seat mounting device embodying the principles and concepts of an embodiment of the disclosure and generally designated by the reference numeral 10 will be described.

As best illustrated in FIGS. 1 through 8, the vehicle seat mounting device 10 generally comprises a first mounting element 12, which in turn comprises a pair of side members 14. Each side member 14, which comprises at least one compressible element 16, is configured to be attachable to a chassis 18 so that the pair of side members 14 defines a seating area 20. For example, each side member 14 may be attachable to a respective opposed side 22 of a framework 24 to define a seating area 20 of a single seat vehicle, and, in particular, which will be used in as a sprint car, a midget car, or the like. The present invention also anticipates more than one first mounting element 12 being attached to a chassis 18 intended to seat than one person.

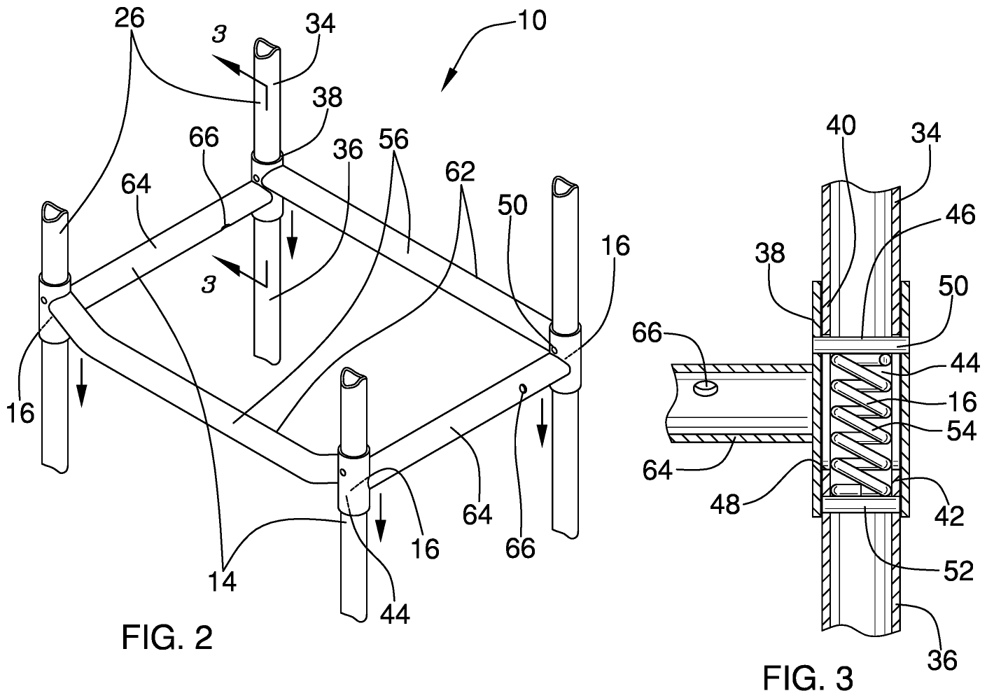

As is shown in FIG. 2, each side member 14 comprises a pair of tubes 26, the tubes 26 of which are configured to be attachable to a pair of substantially horizontal elements 28 of the chassis 18 so that the tubes 26 of are parallel to each other and substantially perpendicular to a bottom 30 of the chassis 18. The tubes 26 could replace structural elements 32 of the chassis 18 or could be added in addition to the structural elements 32.

Each tube 26 comprises an upper segment 34, a lower segment 36, and a coupling sleeve 38. The coupling sleeve 38 is positioned around a lower portion 40 of the upper segment 34 and an upper portion 42 of the lower segment 36 to define a gap 44 between a lower end 46 of the upper segment 34 and an upper end 48 of the lower segment 36. The compressible element 16 is positioned in the gap 44 so that the compressible element 16 is compressed between the upper segment 34 and the lower segment 36 upon application of the force to the bottom 30 of the chassis 18.

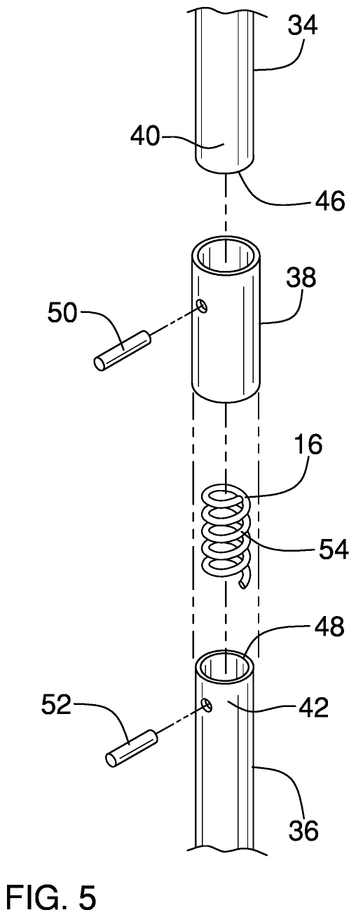

As is shown in FIG. 5, a first pin 50 is attached to the coupling sleeve 38 and is positioned in abutment with the lower end 46 of the upper segment 34. A second pin 52 is attached to the lower segment 36 proximate to the upper end 48, with the compressible element 16 being positioned between the first pin 50 and the second pin 52. The present invention also anticipates plates, discs, or the like being used in place of the first pin 50 and the second pin 52. The compressible element 16 may comprise a compression spring 54, as is shown in FIGS. 3 and 5, or other compressible material, such as, but not limited to, air springs, foams, or the like.

A crossmember 56 is attached to and extends between the side members 14 and across the seating area 20. The crossmember 56 is configured to be attachable to a seat portion 58 of a vehicle seat 60 so that the vehicle seat 60 is mounted to the chassis 18. The compressible elements 16 are configured to at least partially absorb a force that is applied to the bottom 30 of the chassis 18 and substantially parallel to the side members 14, such as when all four wheels of a vehicle comprising the chassis 18 hit the ground at the same time. The compressible elements 16 also are configured to at least partially absorb a vertical component of a force applied angularly to the bottom 30 of the chassis 18, such as may be encountered in a rollover.

The intention of the present invention is not to increase a comfort level of a driver under normal driving conditions. As such, the compressible elements 16 are intended to allow little or no movement of the vehicle seat 60 under normal driving conditions. Rather, the present invention is intended to reduce a risk of sustaining a spinal or back injury by allowing the vehicle seat 60, and thus the driver, to move a small distance when an extreme force, on the order of two gravitational force equivalents or more, is applied to the bottom 30 of the chassis 18.

The crossmember 56 may comprise a pair of crossbars 62, with each crossbar 62 being attached to and extending between a coupling sleeve 38 on a respective tube 26 of one of the pair of tubes 26 and a coupling sleeve 38 on an associated tube 26 of the other of the pair of tubes 26. The crossbars 62 of the pair of crossbars 62 thus are parallel, as is shown in FIG. 2.

The vehicle seat mounting device 10 also may comprise a pair of crossbeams 64, with each crossbeam 64 being attached to and extending between the tubes 26 of a respective pair of tubes 26. As is shown in FIG. 2, the crossbeam 64 is attached to and extends between the coupling sleeves 38 of the respective pair of tubes 26. The present invention anticipates each crossbeam 64 having a hole 66 positioned therethrough allowing for attachment of a seatbelt 68, a safety harness, or the like.

Additionally, the present invention anticipates the crossmember 56 being of a variety of other configurations, such as, but not limited to, plates, more than two crossbars 62, crossbars 62 extending between the crossbeams 64, and the like, all of which would require the coupling sleeves 38 to move simultaneously and to the same degree upon application of the force to the bottom 30 of the chassis 18.

As a back portion 70 of the vehicle seat 60 often is fixedly attached to the chassis 18, the present invention anticipates a second mounting element 72, which is configured to be attachable to the chassis 18 and to the back portion 70 of the vehicle seat 60 so that the back portion 70 is slidable relative to the chassis 18 concurrent with movement of the seat portion 58. The present invention anticipates the second mounting element 72 and the first mounting element 12 being attached to the vehicle 60 by methods known to those skilled in the art of mounting vehicles seats, such as, but not limited to, welding, bolting, clamping, and the like.

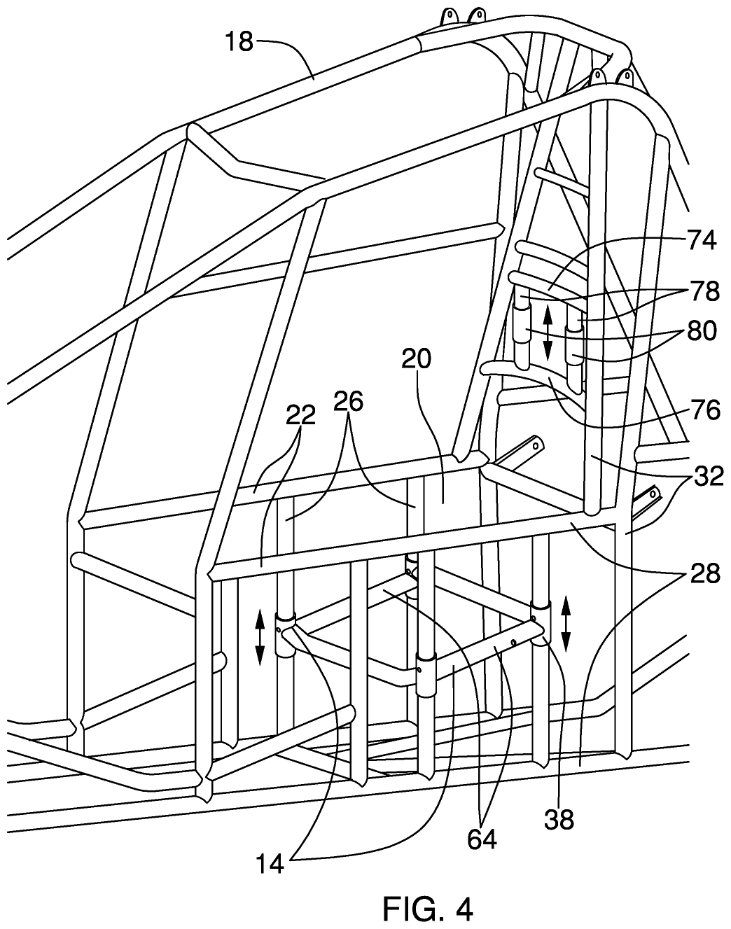

As is shown in FIG. 4, the second mounting element 72 comprises an upper beam 74 and a lower beam 76, which are attached to and which extend between a pair of structural elements 32 of the chassis 18. The upper beam 74 and the lower beam 76 could replace structural elements 32 of the chassis 18 or could be added in addition to the structural elements 32. A pair of uprights 78 is attached to and extends between the upper beam 74 and the lower beam 76. The uprights 78 of the pair of uprights 78 are parallel to each other and to the tubes 26. Each slip sleeve 80 of a pair of slip sleeves 80 is slidably positioned around a respective upright 78 and is configured to be attachable to the back portion 70 of the vehicle seat 60.

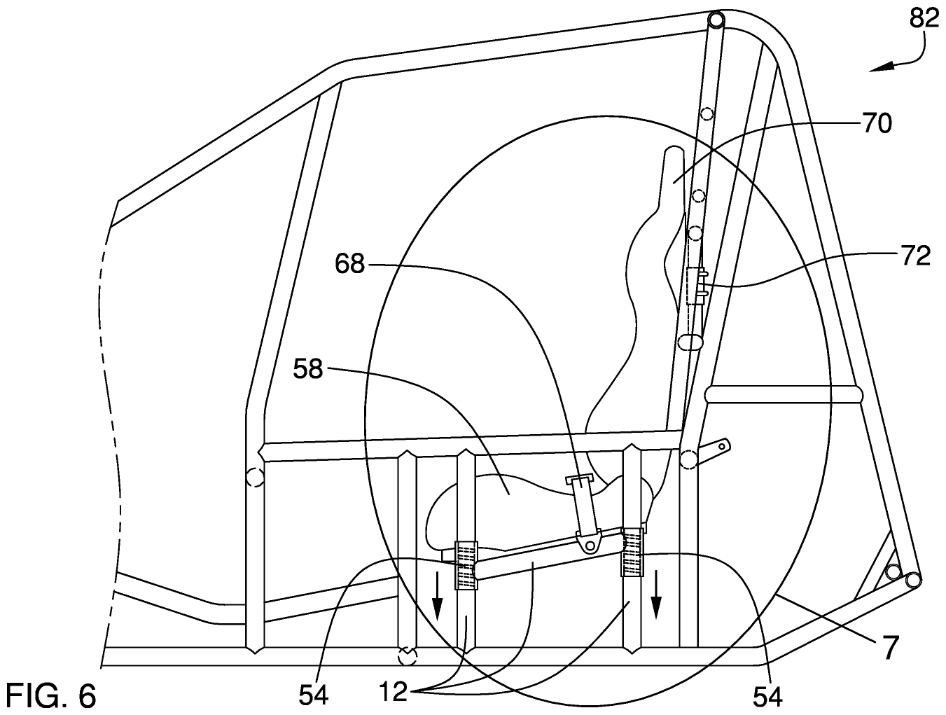

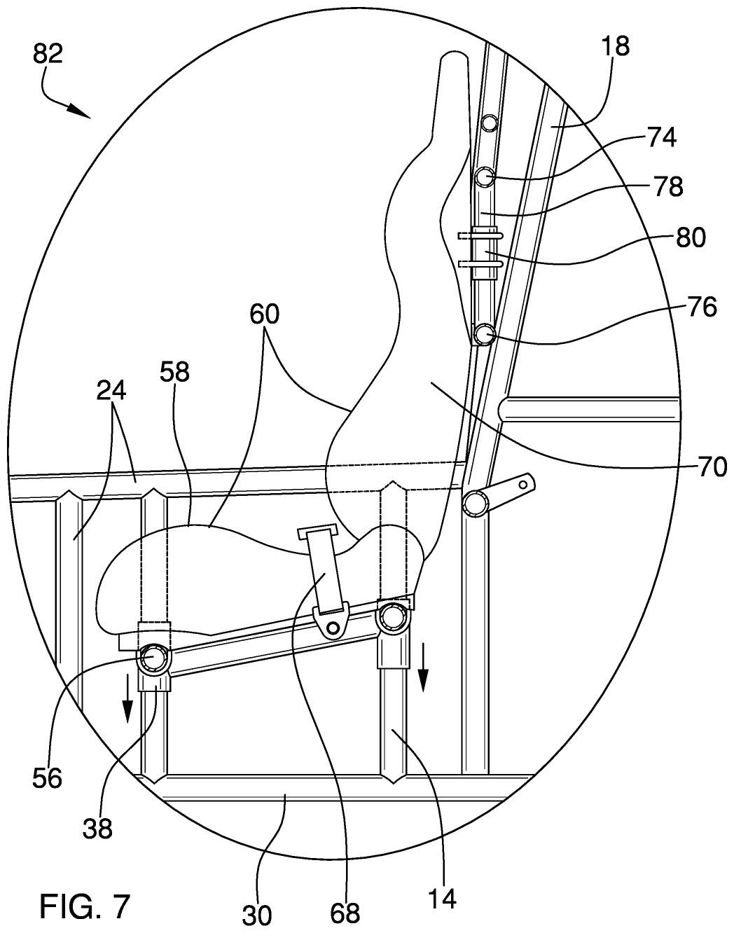

The present invention also anticipates a vehicle seat mounting system 82, which comprises a chassis 18, a vehicle seat 60, and a vehicle seat mounting device 10, according to the specification above and as is shown in FIGS. 6 and 7. A pair of side members 14 of the vehicle seat mounting system 82 are attached to the chassis 18, such that the pair of side members 14 defines a seating area 20. Each side member 14 comprises at least one compressible element 16. A crossmember 56 of the vehicle seat mounting system 82 is attached to and extends between the side members 14 and across the seating area 20. The crossmember 56 is attached to a seat portion 58 of the vehicle seat 60 so that the vehicle seat 60 is mounted to the chassis 18. The compressible elements 16 are configured to at least partially absorb a force applied to a bottom 30 of the chassis 18 and substantially parallel to the side members 14.

In use, the vehicle seat mounting device 10 enables a method of reducing a risk of sustaining a spinal or back injury 84. The method 84 comprises a provision step 86, which entails providing a chassis 18, a vehicle seat 60, and a vehicle seat mounting device 10, according to the specification above. A first assembly step 88 of the method 84 is attaching the side members 14 to the chassis 18 so that the pair of side members 14 defines a seating area 20 with the crossmember 56 extending across the seating area 20. A second assembly step 90 of the method 84 is attaching a seat portion 58 of the vehicle seat 60 to the crossmember 56. A use step 92 of the method 84 is driving a vehicle comprising the chassis 18. The compressible elements 16 are configured to at least partially absorb a force applied to a bottom 30 of the chassis 18 and substantially parallel to the side members 14, thereby reducing a risk of sustaining a spinal or back injury to a driver.

More specifically, when a driver of a sprint car loses control of the sprint car, through one of a multitude of consequences, there is a substantial risk of rollover of the sprint car or the sprint car becoming airborne. While the chassis 18 is designed to keep the seat portion 58 stable relative to the chassis 18 to avoid injury the driver from lateral and centrifugal forces, there exists a danger to the driver if the sprint car leaves the ground and subsequently lands simultaneously on all four tires since the jarring force of the ground stopping the chassis will be transferred as compression forces to the spine of the driver and creating a risk of vertebral damage. The coupling sleeves 38 and slip sleeves 80 allow for between about 1.0 inches and 4.0 inches of downward vertical movement relative to the chassis. The compressible elements 16 will typically resist a combined force equal to greater than 2.0 gₙ, where the resistance to compression is calibrated using a conventional seat and a typical weight of a driver of the sprint car. Thus, should the calculated weight of the seat and the driver be approximately 200 lbs, the force required to simultaneously compress all of the compressible elements 16 would be equal or greater than 400 lbs. It is important that the force resisting compression be great enough that the seat portion 58 does not move under normal driving conditions which could lead the driver to feel “loose” relative to the chassis 18. Depending on certain conditions, the combined force of resistance of the compressible elements 16 may therefore be equal to or greater than 4.0 gₙ. While the slip sleeves 80 only allow for a small amount of vertical travel, the cushioning affect on the driver's spine is substantial.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle seat mounting device comprising a first mounting element, the first mounting element comprising:
a pair of side members, each side member being configured to be attachable to a chassis, such that the pair of side members defines a seating area, each side member comprising at least one compressible element; and
a crossmember attached to and extending between the side members and across the seating area, the crossmember being configured to be attachable to a seat portion of a vehicle seat, such that the vehicle seat is mounted to the chassis, wherein the compressible elements are configured for at least partially absorbing a force applied to a bottom of the chassis and substantially parallel to the side members.

2. The vehicle seat mounting device of claim 1, further including:
each side member comprising a pair of tubes configured to be attachable to a pair of substantially horizontal elements of the chassis, such that the tubes of the pair of tubes are parallel, and such that the tubes are substantially perpendicular to a bottom of the chassis, each tube comprising:
an upper segment,
a lower segment, and
a coupling sleeve positioned around a lower portion of the upper segment an upper portion of the lower segment defining a gap between a lower end of the upper segment and an upper end of the lower segment; and
the compressible element being positioned in the gap, such that the compressible element is compressed between the upper segment and the lower segment upon application of the force to the bottom of the chassis.

3. The vehicle seat mounting device of claim 2, further including:
a first pin attached to the coupling sleeve and positioned in abutment with the lower end of the upper segment; and
a second pin attached to the lower segment proximate to the upper end, the compressible element being positioned between the first pin and the second pin.

4. The vehicle seat mounting device of claim 2, wherein the compressible element comprises a compression spring.

5. The vehicle seat mounting device of claim 2, wherein the crossmember comprises a pair of crossbars, each crossbar being attached to and extending between a coupling sleeve on a respective tube of one of the pair of tubes and a coupling sleeve on an associated tube of the other of the pair of tubes, such that the crossbars of the pair of crossbars are parallel.

6. The vehicle seat mounting device of claim 2, further including a pair of crossbeams, each crossbeam being attached to and extending between the tubes of a respective pair of tubes.

7. The vehicle seat mounting device of claim 6, wherein the crossbeam is attached to and extends between the coupling sleeves of the respective pair of tubes.

8. The vehicle seat mounting device of claim 2, further including a second mounting element configured to be attachable to the chassis and to a back portion of the vehicle seat, such that the back portion is slidable relative to the chassis concurrent with movement of the seat portion.

9. The vehicle seat mounting device of claim 8, wherein the second mounting element comprises:
an upper beam attached to and extending between a pair of structural elements of the chassis;
a lower beam attached to and extending between the pair of structural elements of the chassis;
a pair of uprights attached to and extending between the upper beam and the lower beam, such that the uprights of the pair of uprights are parallel to each other and to the tubes; and
a pair of slip sleeves, each slip sleeve being slidably positioned around a respective upright and being configured to be attachable to the back portion of the vehicle seat.

10. A vehicle seat mounting system comprising a chassis, a vehicle seat, and a vehicle seat mounting device, the vehicle seat mounting device comprising a first mounting element, the first mounting element comprising:
a pair of side members attached to the chassis, such that the pair of side members defines a seating area, each side member comprising at least one compressible element; and
a crossmember attached to and extending between the side members and across the seating area, the crossmember being attached to a seat portion of the vehicle seat, such that the vehicle seat is mounted to the chassis, wherein the compressible elements are configured for at least partially absorbing a force applied to a bottom of the chassis and substantially parallel to the side members.

11. The vehicle seat mounting system of claim 10, further including:
each side member comprising a pair of attached to a pair of substantially horizontal elements of the chassis, such that the tubes of the pair of tubes are parallel, and such that the tubes are substantially perpendicular to a bottom of the chassis, each tube comprising:
an upper segment,
a lower segment, and
a coupling sleeve positioned around a lower portion of the upper segment an upper portion of the lower segment defining a gap between a lower end of the upper segment and an upper end of the lower segment; and
the compressible element being positioned in the gap, such that the compressible element is compressed between the upper segment and the lower segment upon application of the force to the bottom of the chassis.

12. The vehicle seat mounting system of claim 11, further including:
a first pin attached to the coupling sleeve and positioned in abutment with the lower end of the upper segment; and
a second pin attached to the lower segment proximate to the upper end, the compressible element being positioned between the first pin and the second pin.

13. The vehicle seat mounting system of claim 11, wherein the compressible element comprises a compression spring.

14. The vehicle seat mounting system of claim 11, wherein the crossmember comprises a pair of crossbars, each crossbar being attached to and extending between a coupling sleeve on a respective tube of one of the pair of tubes and a coupling sleeve on an associated tube of the other of the pair of tubes, such that the crossbars of the pair of crossbars are parallel.

15. The vehicle seat mounting system of claim 11, further including a pair of crossbeams, each crossbeam being attached to and extending between the tubes of a respective pair of tubes.

16. The vehicle seat mounting system of claim 15, wherein the crossbeam is attached to and extends between the coupling sleeves of the respective pair of tubes.

17. The vehicle seat mounting system of claim 11, further including a second mounting element attached to the chassis and to a back portion of the vehicle seat, such that the back portion is slidable relative to the chassis concurrent with movement of the seat portion.

18. The vehicle seat mounting system of claim 17, wherein the second mounting element comprises:
an upper beam attached to and extending between a pair of structural elements of the chassis;
a lower beam attached to and extending between the pair of structural elements of the chassis;
a pair of uprights attached to and extending between the upper beam and the lower beam, such that the uprights of the pair of uprights are parallel to each other and to the tubes; and
a pair of slip sleeves, each slip sleeve being slidably positioned around a respective upright and attached to the back portion of the vehicle seat.

19. A method of reducing a risk of sustaining a spinal or back injury comprising the steps of:
providing a chassis, a vehicle seat, and a vehicle seat mounting device, the vehicle seat mounting device comprising a first mounting element comprising:
a pair of side members being configured to be attachable to the chassis, each side member comprising at least one compressible element, and
a crossmember attached to and extending between the side members, the crossmember being configured to be attachable to a seat portion of a vehicle seat, such that the vehicle seat is mounted to the chassis;
attaching the side members to the chassis, such that the pair of side members defines a seating area with the crossmember extending across the seating area;
attaching a seat portion of a vehicle seat to the crossmember; and
driving a vehicle comprising the chassis, wherein the compressible elements are configured for at least partially absorbing a force applied to a bottom of the chassis and substantially parallel to the side members.

20. The method of claim 19, further including:
the provision step including provision of a second mounting element configured to be attachable to the chassis and to a back portion of the vehicle seat, such that the back portion is slidable relative to the chassis concurrent with movement of the seat portion;
a first additional step of attaching the second mounting element to the chassis; and
a second additional step of attaching the back portion of the vehicle seat to the second mounting element.
